(19) United States
(12) Patent Application Publication
(10) Pub. No.: US 2006/0197001 A1
(43) Pub. Date: Sep. 7, 2006

(54) Optical device mount

(76) Inventors: Cary D. Parker, Torrance, CA (US); Gwen Parker, Torrance, CA (US)

Correspondence Address: MARC E. HANKIN, ESQ., 11414 THURSTON CIRCLE, LOS ANGELES, CA, 90049, US

(21) Appl. No.: 11/073,776

(22) Filed: Mar. 6, 2005

(51) Int. Cl. F16B 1/00; E04G 3/00

(52) U.S. Cl. 248/230.8

(57) ABSTRACT

This invention discloses a device for mounting optical devices, such as cameras, binoculars, and telescopes, onto fixed objects such as trees, poles, and posts. One end of the optical device mount serves to mount and position the optical device while the other end of the mount includes a mechanism to securely attach to the fixed object. The mount includes a means for quickly and securely attaching the mount to the object by an attached strap that is connected to a ratchet and pawl mechanism. Additional embodiments disclose variations in the device that allow for greater flexibility in the camera's position.

### FIELD OF INVENTION

This invention relates, generally, to optical device mounts; more particularly to optical device mounts that can be easily and securely attached to fixed objects such as trees, posts, poles, or other similar objects, regardless of their shape or size.

### BACKGROUND

The optical device arts, including photography and telescopy, require rigid and steady mountings for optical devices. In the field of photography, for example, tripods are regularly used by photographers in order to steadily mount the camera and allow for higher quality photographs and longer film exposure times by minimizing vibrations and other distortions of the camera position. Similarly, in fields such as bird watching or surveying, steady mounts are needed for binoculars, transits, or other optical devices so that the enlarged image viewed through the eyepiece does not appear distorted or shaky.

Meanwhile, because the optical arts are often practiced outdoors and/or in remote locations, lightweight and flexible mounts are needed that can be easily carried, quickly set-up, and provide durable and steady support for the optical device. While the ideal optical device mount would provide resistance to vibration and movement through high mass and inertia, such a mount would prove impractical in many instances where portable and easily transportable mounts are needed. Several lightweight and flexible mounts have been developed in order to overcome these obstacles.

Conventional tripods, such as the tripod disclosed in U.S. Pat. No. 4,324,477 to Miyazaki, allow for steady mounting of optical devices by distributing the device's weight over the tripod's three, horizontally-opposed legs. Meanwhile, because the tripods are usually collapsible and adjustable, they are also portable for easy transportation. These devices are limited, however, because as their mass is increased in order to increase their stability, the more unwieldy they become. Further, tripods require relatively flat surfaces on which to be placed. Other devices, known as unipods, rely on only one leg for support and are thus more portable than tripods. At the same time, because unipods only provide vertical support, the optical device must be held by the user and, thus, not only is subject to vibrations by the user's hand, but also, the user must use his or her hand(s) to hold the optical device when it is in use.

Another class of optical mounts has been developed that attaches to fixed objects such as trees or poles that are securely anchored to the ground, and rely upon the fixed object's mass and self-anchoring in order to provide support to the optical device. These devices, thus, allow a camera to be mounted in locations where the floor is unsuitable for supporting a tripod. U.S. Pat. No. 6,330,992 to Swayhoover et al., for example, discloses an apparatus for mounting cameras that includes a cushioned pad and a strap that can mount the camera to fixed objects such as chairs. This apparatus is limited, however, because it can only be used to mount cameras onto horizontal surfaces. Another device, disclosed in U.S. Pat. No. 5,275,364 to Burger et al., discloses a camera support that is mountable between two spaced surfaces. This device is also limited, however, because it cannot be used with a single, free-standing object such as a tree or a telephone pole and must be mounted to two spaced surfaces within relatively close proximity to one another.

Another such device, disclosed in U.S. Pat. No. 5,649,257 to Kempka, is a Tree Mounted Camera Support that attaches a camera to the trunk of a tree by a triangle-shaped camera mount with a pair of adjustable straps. This device allows for steady mounting of a camera by relying upon the mass and anchoring of the tree. The device, however, has many shortcomings because the tree-mount portion of the device is relatively long and thus must be mounted to a long, straight portion of a tree trunk.

U.S. Pat. Nos. 5,622,342, 6,021,948, and 6,349,905 to Mills all disclose apparatuses for mounting optical devices to vertical objects such as trees. These devices are limited, however, because their tree-mount portion is relatively long and, thus, must be mounted to a long, straight section of the support. Further, the stability of these apparatuses is limited because the patents do not disclose an effective attachment means that may be used with a wide variety of objects.

A flexible camera mount that can be attached to a variety of objects is disclosed in U.S. Pat. Nos. 5,497,214 and Des. 363,945. The mount includes a concave base plate that attaches to a support object such as a tree via a flexible strap. The base plate is connected to a support plate, which suspends the camera, via two arms that are allowed to adjustably articulate along one another and allow for the position of the camera to be varied. The stability of this mount is, however, limited because of the many additional parts which might come loose, and because there are three additional joints needed for the two articulating arms. Also, the stability of the mount is limited because it does not disclose an effective attachment mechanism to securely attach the mount to a support object. Further, the mount provides for limited stability because the concave-shaped base plate does not provide for a secure means of attaching the mount to a wide variety of support objects. Moreover, the device is so large that it is unwieldy and impractical for many useful applications, and cannot easily be transported and set up in narrow quarters.

Therefore, there is a long felt need in the art for an optical device mount that can securely and rigidly support optical devices by attaching to a variety of support objects while remaining lightweight and portable such that it can easily be carried on one's person or in a relatively compact space.

### SUMMARY OF THE INVENTION

This invention is directed towards overcoming the above shortcomings by providing an optical device mount that can securely and rigidly mount to a wide variety of objects and provide a support for optical devices while remaining lightweight and easily transportable. Different optical device supports can be used within the framework of this invention in order to mount many different types of optical devices.

Generally speaking, the invention consists of three separate assemblies that combine to form the optical device mount. The first such assembly, referred to as a head, serves to mount the camera to the optical device mount while allowing the position and angle of the camera to be varied by the user. The second such assembly, referred to as an attachment-base, serves to securely attach the optical device mount to a fixed support object. The third assembly, referred to as a boom, serves to connect the head to the attachment-base and, in one configuration, also allows the distance between the two to be varied.

In one embodiment of the invention, the optical device mount is designed to mount a camera on the support-base, which is part of the head, and the support-base includes a standard threaded mount for attaching still or motion picture cameras. When threaded to a camera body, the threaded mount works to securely mount and support a camera. The support-base is allowed to tilt via a locking tilting-joint, located below the support-base that pivots along a horizontal fulcrum within the joint and tilts the support-base along its horizontal plane. The support-base and locking tilting-joint are also allowed to rotate by a locking panning-joint below the tilting-joint that rotates the support-base 360 degrees along its vertical fulcrum. The support-base, tilting-joint, and panning-joint together comprise the head, which is connected to the boom by a second tilting-joint, called a head tilting-joint. The head tilting-joint also pivots along a horizontal fulcrum and allows the head to rotate approximately 180 degrees. The fulcrum of the head tilting-joint is horizontal and lies perpendicular to the direction of the boom. The fulcrum of the support-base tilting-joint, on the other hand, is horizontal but can be rotated to any direction by varying its position via the panning-joint. Together, the support-base tilting-joint, panning-joint, and head tilting-joint allow the user a great deal of flexibility in choosing a position and angle for the camera.

In another embodiment of the invention, the head includes a single, locking ball-joint connected to a support-base, rather than the support-base tilting-joint and panning-joint. The locking ball-joint allows a great deal of flexibility in the position of the support-base by tilting, panning, and locking along all axes of the ball.

In another embodiment of the invention, the head tilting-joint is eliminated. Thus, the head (consisting of either of two configurations), attaches fixedly and directly to the boom.

The boom's primary function is to connect the head to the attachment-base. This function is carried out through stiff construction that can support the weight of an optical device at the head. The weight of the boom may be reduced by hollowing sections of the boom. In one embodiment of the invention, the length of the boom can be varied with a telescoping sliding-joint included along the length of the boom.

The attachment-base serves to attach the optical device mount to a fixed object such as a tree or pole. In one embodiment of the invention, the attachment-base is configured to securely and firmly attach to a wide variety of objects such as trees, square poles, round poles and other fixed objects that are commonly anchored to the ground. This secure attachment is achieved because the attachment-base is shaped such that its outer edge at the distal end from the boom is knurled and includes a myriad of teeth that allow for secure connection to round objects, such as round poles and trees, of varying diameter. Another edge of the attachment-base, is also knurled and shaped with special teeth that allow for secure connection to square-shaped, rectangular-shaped, or triangular-shaped objects such as angular poles and bollards.

The attachment-base also includes a strap, one end of which is fixed to the attachment-base and the other end of which is, upon attachment, wrapped around the support object and connected to the attachment-base via an improved connection and tightening mechanism. The connection and tightening mechanism includes of a ratchet and pawl that can be tightened by the user. Once wrapped around the support object, the strap is passed through a slit on the ratchet wheel. Then, in order to tighten the strap and fixedly secure the optical device mount, the ratchet is turned by the user using a crank at the top of the optical device mount. The crank is connected to the ratchet wheel via a crank hinge that allows it to pivot as it is turned by the user to be able to be used in tight spaces. The pawl acts to maintain the tension in the strap once it is cranked tight by the user. A quick release lever at the top of the pawl allows the user to disengage the pawl from the ratchet wheel, thereby releasing the tension in the strap. The attachment-base, thus, allows for quick attachment and removal of the optical device mount from a fixed object.

Other features and advantages of this invention will become apparent from the following description of several embodiments of the invention, taken in conjunction with the accompanying drawings, which illustrate, by way of example, the principles of the invention.

### BRIEF DESCRIPTION OF THE DRAWINGS

FIG. 1 is an illustration in perspective view of one embodiment of the invention while attached to a tree.

FIG. 2 is an illustration from a side view of one embodiment of the invention.

FIG. 3A is a detailed illustration from a side view that shows the range of motion of the head along the head tilting-joint in one embodiment of the invention.

FIG. 3B is a detailed illustration from a side view that shows the range of motion of the support-base along the tilting-joint in one embodiment of the invention.

FIG. 3C is a detailed illustration from a top view that shows the range of motion for the support-base along the panning-joint in one embodiment of the invention.

FIG. 4A is a detailed illustration from a side view of the attachment-base in one embodiment of the invention.

FIG. 4B is a detailed illustration from a top view of the attachment-base in one embodiment of the invention.

FIG. 5 is an illustration in perspective view of one embodiment of the invention while attached to a square post.

FIG. 6A is an illustration in perspective view of one embodiment of the invention.

FIG. 6B is an illustration in perspective view of one embodiment of the invention.

FIG. 7A is a detailed illustration in perspective view of the attachment-base and strap in one embodiment of the invention.

FIG. 7B is an illustration in side view of one embodiment of the invention while folded for easy transport.

### DETAILED DESCRIPTION OF THE DRAWINGS

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance, “camera” refers to any type of “optical device,” “optical device” refers to any device that is used to produce or control light, and “fixed object” refers to any object that stands on the ground.

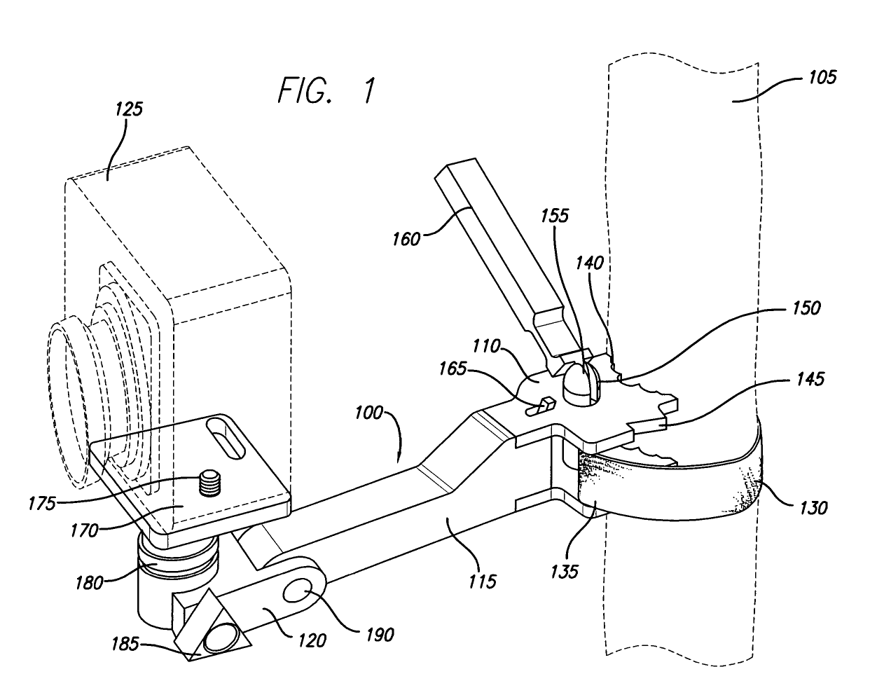

FIG. 1 is an illustration in perspective view of one embodiment of the invention while attached to a tree. A optical device mount 100 is shown while attached to a tree 105 and while supporting a camera 125. The optical device mount is comprised of three assemblies: an attachment-base 110, for securing the optical device mount 100 to a tree or other similar object, a head 120, for supporting and adjusting the angle of the optical device, and a boom 115, for connecting the attachment-base 110 to the head 120. The attachment-base 110 attaches to the tree 105 using a strap 130 that has a fixed end 135 that is connected to the attachment-base 110 and a loose end that, once wrapped around the tree 105, is connected to the ratchet and pawl mechanism 150 and tightened by turning a crank 160. The crank 160 is connected to the ratchet and pawl mechanism 150 by a crank hinge 155 that allows the crank 160 to articulate back and forth for easier cranking by the user. When the crank 160 is turned by the user, the ratchet and pawl mechanism 150 is engaged to tighten the strap 130 and securely attach the optical device mount 100 to the tree 105. The attachment-base includes a concave, crenellated outside surface 140 with teeth that are adapted to attaching the optical device mount 100 to round surfaces such as trees and round posts. Another outside surface 145 of the of the attachment-base is crenellated with teeth that are adapted to attaching the optical device mount 100 to square surfaces such as square posts and bollards. A release lever 165 allows the user to release the ratchet and pawl mechanism 150, loosen the tension in the strap 130, and remove the optical device mount 100 from the tree 105. The boom 115 serves to connect the head 120 to the attachment-base 110, laterally outwards from the tree 105. The head 120 includes a support-base 170 and a threaded mount 175 that are adapted to mount to standard camera mountings. The head is allowed to tilt by a head tilting-joint 190, that connects the head 120 to the boom 115. The support-base 170 is also allowed to rotate by the panning-joint 180 that can be locked and unlocked by the user using a thumbnut 185.

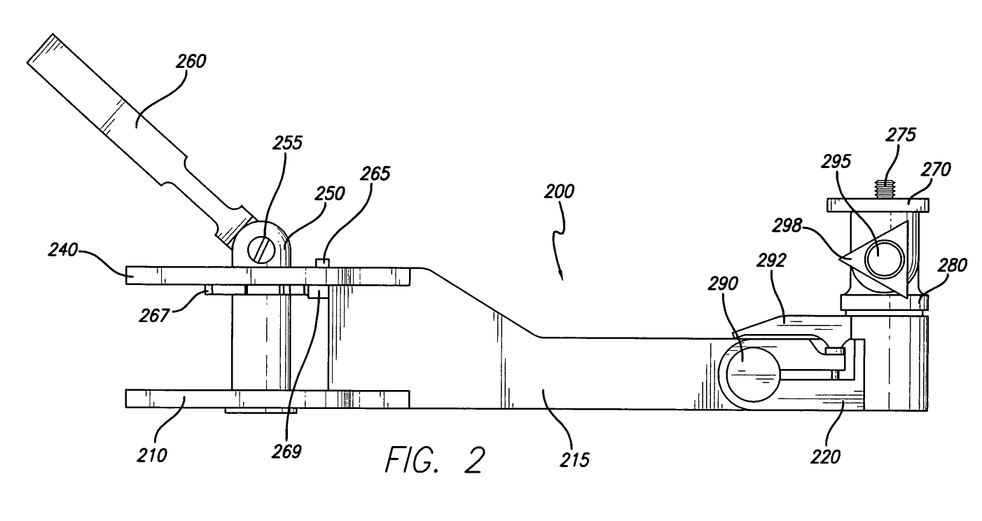

FIG. 2 is an illustration from a side view of one embodiment of the invention. An optical device mount's 200 three assemblies: the attachment-base 210, boom 215, and head 220. The ratchet and pawl mechanism 250 is exposed to illustrate the ratchet 267 and pawl 269. The crank hinge 255 serves to connect the crank 260 to the ratchet and pawl mechanism 250. The crenellated outside surface 240 of the attachment-base 210 serves as a secure connection point between the optical device mount 200 and a support object. The boom 215 serves to connect the attachment-base 210 to the head 220. The head 220 is connected to the boom 215 by the head tilting-joint 290, which is locked and unlocked by the user using a release clamp 292. The head also includes a support-base 270 and threaded mount 275, that are adapted to mount to standard optical device mountings. The support-base 270 is allowed to tilt by a tilting-joint 295 that is locked and unlocked by a thumbnut 298. The support-base 270 is also allowed to rotate by a panning joint 280.

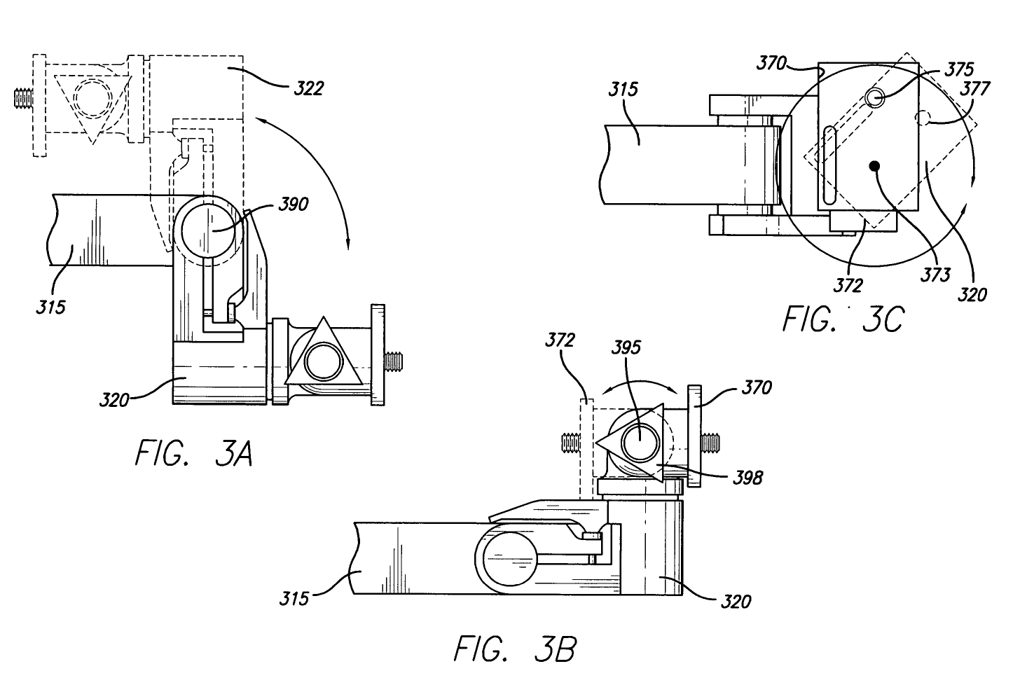

FIG. 3A is a detailed illustration from a side view that shows the range of motion of the head 320 along the head tilting-joint 390 in one embodiment of the invention. The head 320 is shown as it is connected to the boom 315 by the head tilting-joint 390. The head is shown in its extreme lowered position 320 and its extreme raised position 322, to illustrate the range of motion of the head 320 along the head tilting joint 390.

FIG. 3B is a detailed illustration from a side view that shows the range of motion of the support-base 370 along the tilting-joint 395 in one embodiment of the invention. The head 320 is shown as connected to the boom 315 and supporting the support-base 370. The support-base 370 is connected to the head 320 by the tilting-joint 395 that allows the support-base 370 to tilt back and forth. The support-base 370 is illustrated in its extreme forward tilt position 370 and its extreme backward tilt position 372 in order to illustrate its range of motion. The tilting-joint 395 can be locked and unlocked by the user by tightening and loosening a thumbnut 398.

FIG. 3C is a detailed illustration from a top view that shows the range of motion for the support-base 370 along the panning-joint 373 in one embodiment of the invention. The support-base 370 and threaded mount 375 are illustrated as connected to the head 320 and boom 315. The support-base 370 and threaded mount 375 are allowed to rotate along the panning-joint 373 to any angle desired by the user. An alternate, rotated position for the support-base and threaded mount is illustrated in 372 and 377.

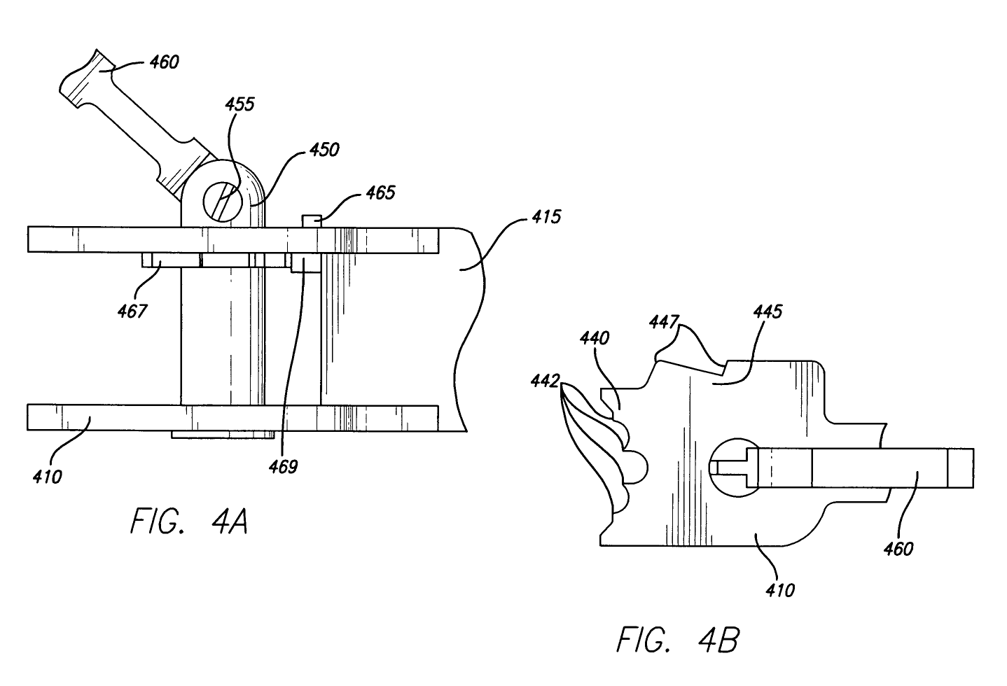

FIG. 4A is a detailed illustration from a side view of the attachment-base 410 in one embodiment of the invention. The attachment-base 410 is illustrated as attached to the boom 415. The ratchet and pawl mechanism 450 is enlarged to illustrate its constituent parts, including the ratchet 467, the pawl 469, and the release lever 465. The crank 460 is also illustrated as it is connected to the ratchet and pawl mechanism 450 by the crank hinge 455.

FIG. 4B is a detailed illustration from a top view of the attachment-base 410 in one embodiment of the invention. This illustration shows the attachment-base 410 and the crank 460 while the crank 460 is folded down and pointing rearwards. The concave, crenellated outside surface 440 of the attachment-base 410 includes several teeth 442 and serves to allow the optical device mount to be securely attached to round objects such as trees and round posts. A second crenellated outside surface 445 of the attachment-base 410 is generally straight in shape and also includes several teeth 447 that are specially shaped to allow the optical device mount to be attached to square objects such as square posts and bollards.

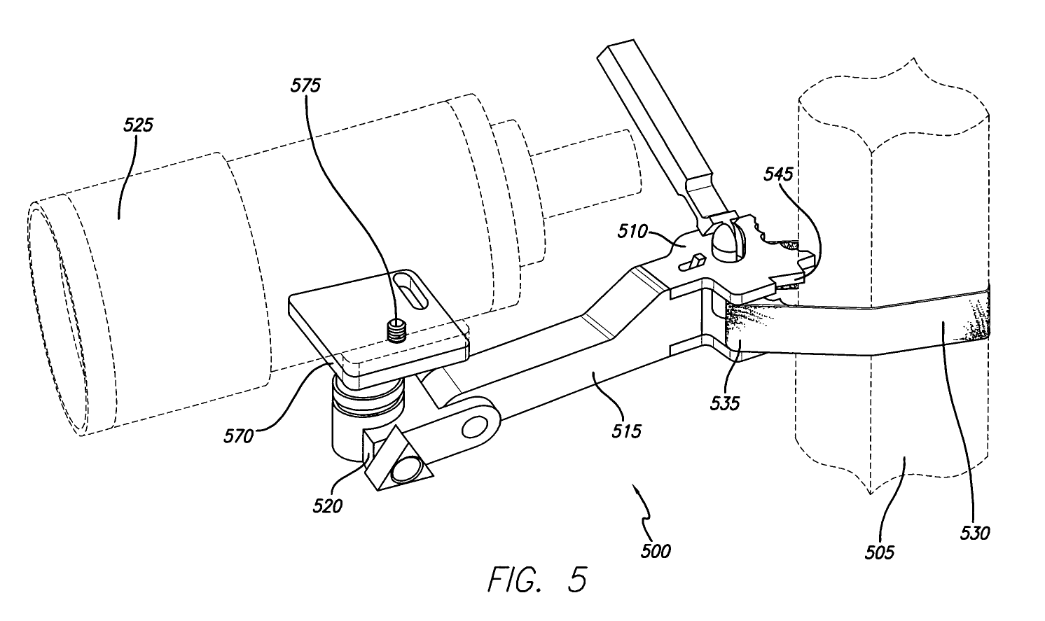

FIG. 5 is an illustration in perspective view of one embodiment of the invention while attached to a square post. An optical device mount 500 is illustrated while attached to a square post 505. This figure illustrates the manner in which the second crenellated outside surface 545 of the attachment-base 510 mates with the edges of the square post 505. The fixed end 535 of the strap 530 is connected to the attachment-base 510 while the strap 530 is wrapped around the square post 505 and tightened to attach the optical device mount 500. The boom 515 projects laterally outwards to support the head 520. This configuration of the optical device mount 500 is specially adapted to mount telescopes 525 with a specially configured support-base 570 and threaded mount 575 that mounts standard telescope mountings.

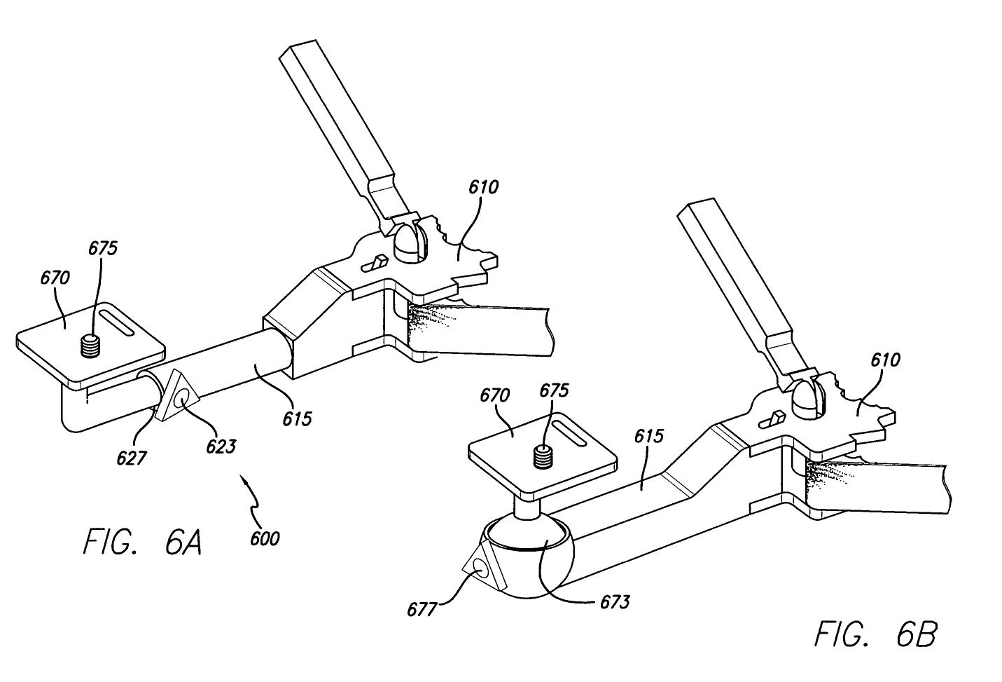

FIG. 6A is an illustration in perspective view of one embodiment of the invention. This configuration of the optical device mount 600 includes a telescoping boom 615 with a sliding joint 627 and locking thumbnut 623 such that the distance between the attachment-base 610 and support-base 670 and threaded mount 675 can be varied by the user.

FIG. 6B is an illustration in perspective view of one embodiment of the invention. In this embodiment of the invention, the support-base 670 and threaded mount 675 are attached to a ball joint 673. The ball joint 673 allows the angle of the support-base 670 to be widely varied by the user and is fixed into position with a locking thumbnut 677. The ball joint 673 is attached to the boom 615 which is, in turn, connected to the attachment-base 610.

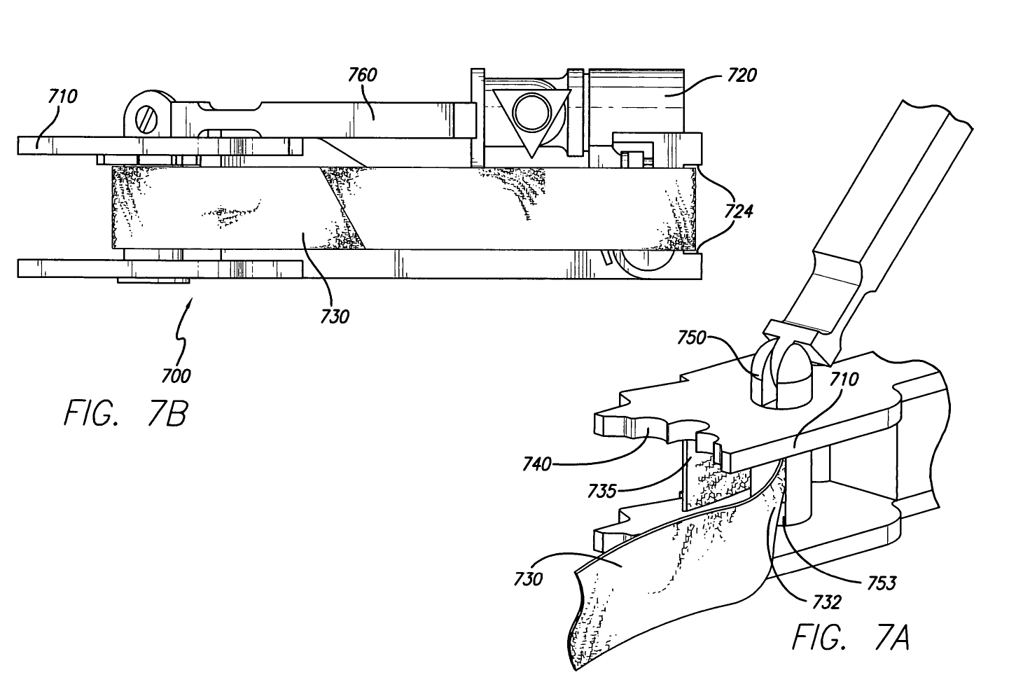

FIG. 7A is a detailed illustration in perspective view of the attachment-base and strap in one embodiment of the invention. The attachment-base 710 is illustrated to show the concave, crenellated outside surface 740, the strap 730, and the ratchet and pawl mechanism 750. A fixed-end 735 of the strap 730 remains fixed to the attachment-base 710 while the loose-end 732 of the strap 730 is passed through a slit 753 in the ratchet and pawl mechanism 750, allowing the strap 730 to be tightened around a fixed object.

FIG. 7B is an illustration in side view of one embodiment of the invention while folded for easy transport. An optical device mount 700 is illustrated while the head 720 is folded upwards and the crank 760 is folded downwards, for easy transport. The strap 730 is wrapped around the attachment-base 710 and through a groove 724 at the underside of the head 720, allowing the user to securely and compactly transport the optical device mount.

I claim:

1. An optical device mount, comprising,
an attachment-base suited to attaching said optical device mount to a variety of fixed objects, said attachment-base comprising an attachment mechanism and one or more knurled edges,
said attachment mechanism comprising a strap and a ratchet and pawl mechanism connected to a hand crank,
said strap comprising a fixed end and a loose end,
said ratchet and pawl mechanism configured such that said loose end of strap can be wrapped around a fixed object, affixed to said ratchet, and said ratchet can be cranked by a user in order to increase the tension in the strap and thereby attach the optical device mount to the object,
said ratchet and pawl mechanism also being configured such that said ratchet and pawl mechanism can be disengaged by a lever connected to said pawl,
said knurled edges comprising a plurality of teeth arranged along the edges of said optical device mount, said teeth configured in one or more of the following configurations,
said knurled edge being generally concave in shape and crenellated such that said teeth allow the optical device mount to securely grip a variety of round objects, or
said knurled edge being generally straight in shape and crenellated such that said teeth allow the optical device mount to securely grip a variety of angular objects with at least one relatively straight edge and at least one angle,
a support-base for supporting an optical device, and
a boom that connects said attachment-base to said support-base.

2. An optical device mount as defined in claim 1 wherein said support-base includes a threaded mount that attaches to standard still and motion picture camera mountings.

3. An optical device mount as defined in claim 1 wherein said support-base includes a threaded mount that attaches to standard binocular and telescope mountings.

4. An optical device mount as defined in claim 1 wherein said support-base includes a mounting that can be adapted to mount cameras, binoculars, telescopes, or other optical devices.

5. An optical device mount as defined in claim 2 wherein a locking swivel joint is used to mount said support-base to said boom, said locking swivel joint configured such that said support-base can be tilted along the horizontal plane.

6. An optical device mount as defined in claim 5 wherein a locking panning joint is used to mount said locking swivel joint to said boom, said locking panning joint configured such that said swivel joint can be rotated in the vertical plane.

7. An optical device mount as defined in claim 6 wherein a second locking tilting joint is used to mount said locking panning joint to said boom, said second locking tilting joint configured such that said locking panning joint can be tilted along the horizontal plane.

8. An optical device mount as defined in claim 3 wherein a locking swivel joint is used to mount said support-base to said boom, said locking swivel joint configured such that said support-base can be tilted along the horizontal plane.

9. An optical device mount as defined in claim 8 wherein a locking panning joint is used to mount said locking swivel joint to said boom, said locking panning joint configured such that said swivel joint can be rotated in the vertical plane.

10. An optical device mount as defined in claim 9 wherein a second locking tilting joint is used to mount said locking panning joint to said boom, said second locking tilting joint configured such that said locking panning joint can be tilted along the horizontal plane.

11. An optical device mount as defined in claim 4 wherein a locking swivel joint is used to mount said support-base to said boom, said locking swivel joint configured such that said support-base can be tilted along the horizontal plane.

12. An optical device mount as defined in claim 11 wherein a locking panning joint is used to mount said locking swivel joint to said boom, said locking panning joint configured such that said swivel joint can be rotated in the vertical plane.

13. An optical device mount as defined in claim 12 wherein a second locking tilting joint is used to mount said locking panning joint to said boom, said second locking tilting joint configured such that said locking panning joint can be tilted along the horizontal plane.

14. An optical device mount as defined in claim 1 wherein said boom includes a locking telescopic joint such that the length of said boom can be varied.

15. An optical device mount as defined in claim 7 wherein said boom includes a locking telescopic joint such that the length of said boom can be varied.

16. An optical device mount as defined in claim 10 wherein said boom includes a locking telescopic joint such that the length of said boom can be varied.

17. An optical device mount as defined in claim 13 wherein said boom includes a locking telescopic joint such that the length of said boom can be varied.

18. An optical device mount as defined in claim 1 wherein a locking ball joint is used to connect said support-base to said boom, said locking ball joint configured such that the angle of the support-base can be varied in the vertical and horizontal planes.

19. An optical device mount as defined in claim 2 wherein a locking ball joint is used to connect said support-base to said boom, said locking ball joint configured such that the angle of the support-base can be varied in the vertical and horizontal planes.

20. An optical device mount as defined in claim 3 wherein a locking ball joint is used to connect said support-base to said boom, said locking ball joint configured such that the angle of the support-base can be varied in the vertical and horizontal planes.

21. An optical device mount as defined in claim 4 wherein a locking ball joint is used to connect said support-base to said boom, said locking ball joint configured such that the angle of the support-base can be varied in the vertical and horizontal planes.

22. An optical device mount, comprising,
an attachment-base suited to attaching said optical device mount to a variety of fixed objects, said attachment-base comprising an attachment mechanism and one or more knurled edges,
said attachment mechanism comprising a strap and a strap tightening means,
said knurled edge or edges being arranged along one or more of the edges of said optical device mount,
said knurled edge or edges comprising one or more indentations and being configured to allow the optical device mount to attach to a variety of fixed objects,
a support-base for supporting an optical device, and
boom that connects said attachment-base to said support-base.
